(19) United States
(12) Patent Application Publication
(10) Pub. No.: US 2025/0178958 A1
(43) Pub. Date: Jun. 5, 2025

(54) ARTIFICIAL STONE COMPRISING POLYAMIDES FIBERS AND METHOD OF MAKING SAME

(71) Applicant: CAESARSTONE LTD., Kibbutz Sdot-Yam (IL)

(72) Inventors: Ido WINER, Mizpe Aviv (IL); Shany Rotem YAGEV, Kibutz Sdot Yam (IL); Erez MARGALIT, Moshav Merhavia (IL)

(73) Assignee: CAESARSTONE LTD., Kibbutz Sdot-Yam (IL)

(21) Appl. No.: 18/843,287

(22) PCT Filed: Mar. 2, 2023
(86) PCT No.: PCT/IL2023/050215

§ 371 Date: Sep. 2, 2024

(30) Foreign Application Priority Data
Mar. 3, 2022 (IL) 291107

(51) Int. Cl. C04B 16/06; C04B 24/42; C04B 26/18

(52) U.S. Cl. CPC C04B 16/0691; C04B 24/42; C04B 26/18

(57) ABSTRACT

An artificial stone is disclosed. The artificial stone comprises at least 80 wt. % of an inorganic filler; at least 6 wt. % of a polymeric binder; and polyamide fibers characterized by an average length of between 0.05 to 50 mm, in a weight percentage of at least 0.01 wt. %.

### CROSS REFERENCE TO RELATED APPLICATIONS

This application claims the benefit of priority of Israeli Patent Application No. 291107, filed Mar. 3, 2023, entitled “ARTIFICIAL STONE COMPRISING POLYAMIDES FIBERS AND METHOD OF MAKING SAME”. The contents of the above application is incorporated by reference as if fully set forth herein in its entirety.

### FIELD OF THE INVENTION

The present invention relates generally to slabs from artificial stones. More specifically, the present invention relates to artificial stones comprising polyamides fibers.

### BACKGROUND OF THE INVENTION

Engineered stones (also known in the art as artificial stones, agglomerated stone or quartz slabs) are widely used as building materials e.g., for kitchen countertops, work surfaces, indoor and outdoor floors, wall claddings, dressing tables, bathtubs, washbowls, and interior articles. Artificial stone products are in great demand due to their ability to be manufactured in a wide variety of patterns and colors that cannot be found in nature and to show superior physical and mechanical performance when compared to natural stone.

These artificial stones are generally manufactured by mixing unsaturated polyester thermoset or acrylic thermoset compositions and aggregate and/or mineral, in a single layer. The unsaturated polyester thermoset compositions comprise an oligomeric chain comprised of saturated dicarboxylic acids or its anhydride as well as unsaturated dicarboxylic acid or anhydride. These two acids are reacted with one or more di-alcohols. The Resin mixture also comprises a reactive solvent, e.g., styrene, and cobalt-octoate as a curing process accelerator. The acrylic thermoset compositions comprise monomeric units selected from acrylate, methacrylate, and any derivative thereof and a crosslinker. The aggregate and/or mineral can be any type of quartz, quartzite, feldspar, glass particles, clay, calcium carbonate, aluminum hydroxide, magnesium hydroxide, or any combination thereof. The mixture is substantially homogeneous across the entire slab.

Many attempts were made in order to increase the durability, impact resistance, and flexibility of artificial stones. Additives such as silane, acrylic acid, and methacrylic acid were added to the resin. Silane acts as a binding agent between the aggregates and the acrylic resin and acrylic and methacrylic acids improve the wetting between the two.

In order to further increase the impact resistance, and flexibility of the artificial stones a new approach was used, the addition of polyamides fibers.

### SUMMARY OF THE INVENTION

Some aspects of the invention are directed an artificial stone comprising: at least 80 wt. % of an inorganic filler; at least 6 wt. % of a polymeric binder; and polyamide fibers characterized by an average length of between 0.05 to 50 mm, in a weight percentage of at least 0.01 wt. %.

In some embodiments, the polyamide fibers are further characterized by an average diameter of between 5 to 300 μm. In some embodiments, the ratio between the length to the average diameter of the polyamide fibers is between 50 to 100. In some embodiments, the weight percentage of the polyamide fibers is between 0.01 to 5 wt. %.

In some embodiments, the polymeric binder is a thermoset resin. In some embodiments, the thermoset resin is selected from unsaturated polyester, acrylic, epoxy, polyurethane resin, or any combination thereof. In some embodiments, the weight percentage of the polymeric binder is between 6 to 17 wt. %.

In some embodiments, the artificial stone further comprises a coupling agent. In some embodiments, the weight percentage of the coupling agent is between 0.001 to 1 wt. %. In some embodiments, the coupling agent is silane.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart of a method of making an artificial stone according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

Embodiments of the present invention disclose an artificial stone comprising inorganic filler and a polymeric binder. In some embodiments, the artificial stone further includes polyamides fibers (also known in the art as nylon fibers). In some embodiments, adding at least 0.01 wt. %. polyamides fibers to the artificial stone composition may increase the crack resistance by at least 10% and the impact resistance by at least 10%.

Synthetic polyamides are divided into three groups, aliphatic polyamides, polyphthalamides, and aromatic polyamides, or aramids. Polyamides are made by the formation of an amide function to link two molecules of monomer together. The monomers can be amides themselves (usually in the form of a cyclic lactam such as caprolactam), α,ω-amino acids, or a stoichiometric mixture of a diamine and a diacid.

In some embodiments, the nomenclature used for polyamide polymers uses numbers to describe the number of carbons in each monomer unit, including the carbon(s) of the carboxylic acid. For example, two of the ingredients that are used to synthesize the most common polyamides (e.g., nylon), adipic acid and hexamethylenediamine, each contains six carbon atoms, thus, the product has been named nylon-6,6. Other polyamides of commercial importance include nylons 4,6; 6,10; 6,12; and 12,12—each prepared from diamines and dicarboxylic acids; nylon 11, prepared by step-growth polymerization from the amino acid H₂N(CH₂)10COOH; and nylon 12, made by ring-opening polymerization of a cyclic amide. When extruded into fibers through pores in an industry spinneret, the individual polymer chains tend to align due to viscous flow.

In some embodiments, the polyamide fibers are characterized by an average length of between 0.05 to 50 mm. In some embodiments, the polyamide fibers are characterized by an average length of between 0.001 to 100 mm. In some embodiments, the polyamide fibers are characterized by an average length of between 0.005 to 50 mm. In some embodiments, the polyamide fibers are characterized by an average length of between 0.01 to 50 mm. In some embodiments, the polyamide fibers are characterized by an average length of between 0.02 to 50 mm. In some embodiments, the polyamide fibers are characterized by an average length of between 0.03 to 50 mm. In some embodiments, the polyamide fibers are characterized by an average length of between 0.07 to 40 mm. In some embodiments, the polyamide fibers are characterized by an average length of between 0.1 to 50 mm. In some embodiments, the polyamide fibers are characterized by an average length of between 0.5 to 50 mm. In some embodiments, the polyamide fibers are characterized by an average length of between 1 to 50 mm. In some embodiments, the polyamide fibers are characterized by an average length of between 1 to 100 mm.

In some embodiments, the polyamide fibers are characterized by an average diameter of between 5 to 300 μm. In some embodiments, the polyamide fibers are characterized by an average diameter of between 1 to 300 μm. In some embodiments, the polyamide fibers are characterized by an average diameter of between 3 to 300 μm. In some embodiments, the polyamide fibers are characterized by an average diameter of between 10 to 250 μm. In some embodiments, the polyamide fibers are characterized by an average diameter of between 15 to 200 μm. In some embodiments, the polyamide fibers are characterized by an average diameter of between 10 to 100 μm.

In some embodiments, the ratio between the length to the average diameter of the polyamide fibers is between 50 to 100. In some embodiments, the ratio between the length to the average diameter of the polyamide fibers is between 20 to 200. In some embodiments, the ratio between the length to the average diameter of the polyamide fibers is between 10 to 100. In some embodiments, the ratio between the length to the average diameter of the polyamide fibers is between 20 to 200. In some embodiments, the ratio between the length to the average diameter of the polyamide fibers is between 30 to 150. In some embodiments, the ratio between the length to the average diameter of the polyamide fibers is between 40 to 100. In some embodiments, the ratio between the length to the average diameter of the polyamide fibers is between 50 to 80.

In some embodiments, the polyamide fibers are added a weight percentage of at least 0.01 wt. % of the artificial stone. In some embodiments, the polyamide fibers are added a weight percentage of at least 0.005 wt. % of the artificial stone. In some embodiments, the polyamide fibers are added a weight percentage of at least 0.5 wt. % of the artificial stone. In some embodiments, the weight percentage of the polyamide fibers is between 0.01 to 5 wt. %. In some embodiments, the weight percentage of the polyamide fibers is between 0.001 to 10 wt. %. In some embodiments, the weight percentage of the polyamide fibers is between 0.005 to 5 wt. %. In some embodiments, the weight percentage of the polyamide fibers is between 0.01 to 10 wt. %. In some embodiments, the weight percentage of the polyamide fibers is between 0.01 to 7 wt. %. In some embodiments, the weight percentage of the polyamide fibers is between 0.5 to 10 wt. %. In some embodiments, the weight percentage of the polyamide fibers is between 0.01 to 20 wt. %.

In some embodiments, the artificial stone may include at least 80 wt. % of an inorganic filler. In some embodiments, the artificial stone may include at least 82 wt. % of an inorganic filler. In some embodiments, the artificial stone may include at least 85 wt. % of an inorganic filler. In some embodiments, the artificial stone may include at least 90 wt. % of an inorganic filler. In some embodiments, the artificial stone may include at most 95 wt. % of an inorganic filler. In some embodiments, the artificial stone may include at most 94 wt. % of an inorganic filler. In some embodiments, the artificial stone may include at most 93 wt. % of an inorganic filler. In some embodiments, the artificial stone may include at most 91 wt. % of an inorganic filler.

In some embodiments, the inorganic filler is selected from quartz, feldspar, quartzite amorphous silica, glass particles, frits, or any combination thereof.

In some embodiments, the inorganic filler (or aggregates) is in the form of a plurality of particles having a median diameter ranging from 0.001 to 10 mm or more. As used herein, the term “diameter” may encompass a size of at least one dimension, e.g., length. In some embodiments, the term “diameter” refers to a median size of a plurality of particles. Herein, the term “particles”, refers to one or more particles.

In some embodiments, the inorganic filler may include a mixture of two or more types of aggregates, for example, 50 wt. % quartzite and 50 wt. % quartz, or 20 wt. % quartzite and 80 wt. % quartz.

In some embodiments, the artificial stone may include at least 6 wt. % of polymeric binder. In some embodiments, the artificial stone may include at least 5 wt. % of the polymeric binder. In some embodiments, the weight percentage of the polymeric binder is between 6 to 17 wt. %. In some embodiments, the weight percentage of the polymeric binder is between 5 to 20 wt. %. In some embodiments, the weight percentage of the polymeric binder is between 6 to 15 wt. %. In some embodiments, the weight percentage of the polymeric binder is between 7 to 17 wt. %. In some embodiments, the weight percentage of the polymeric binder is between 7 to 20 wt. %. In some embodiments, the weight percentage of the polymeric binder is between 6 to 16 wt. %.

In some embodiments, the polymeric binder may include, acrylic binder, epoxy, polyurethane, polyester (e.g., unsaturated polyester), and any combination thereof.

In some embodiments, the acrylic binder may include a plurality of monomeric units selected from acrylate, or any derivative thereof.

In some embodiments, the acrylate is selected from methacrylate, methyl methacrylate (MMA), 2-ethylhexyl acrylate (2-EHA), 2-ethylhexyl methacrylate, n-butyl acrylate, n-butyl methacrylate, isobutyl methacrylate, isobornyl acrylate, isobornyl methacrylate, and any derivative or combination thereof. In some embodiments, the monomeric unit comprises 2-EHA and MMA. In some embodiments, the MMA and 2-EHA are present at a weight ratio ranging from 5:1 to 3:1, respectively.

In some embodiments, the polymeric binder may be cross-linked. For example, cross-linked acrylic polymer may include a cross-linker selected from the group comprising of: triethylene glycol diacrylate, trimethylolpropane triacrylate (TMPTA), trimethylolpropane trimethacrylate (TMPTMA), pentaerythritol tetraacrylate, dipentaerithritol hexaacrylate, dendritic acrylates, and methacrylates having at least two functional groups, or any derivative or combination thereof.

In another example, cross-linked polyester may include styrene, triethylene glycol diacrylate, triethylene glycol dimethacrylate or any derivative or combination thereof.

In some embodiments, first layer 10 and second layer 20 may differ from each other in the type of polymeric binder. In such case, each layer may include a polymeric binder having different chemical composition, but the same (ro different) type of aggregate. For example, the polymeric binder of the first layer may be or may include methacrylate and the polymeric binder of the second layer may include or may be methyl methacrylate (MMA). In another example, the first layer may include polyurethane, and the second layer polyester.

In some embodiments, polymeric binder may further include a pigment. For example, the pigment may be selected from titanium-dioxide based pigments, iron-oxide based pigments, chromium-oxide based pigments, zinc-oxide based pigments, or any other organic or metal-oxide-based pigments.

In some embodiments, the polymeric binder may include additional additives. In some embodiments, the polymeric binder may include between 0.1 to 10 wt. % of one or more types of additives. In some embodiments, the additive may be selected from, a UV stabilizer, a wetting agent, an antibacterial additive, an emulsifier, a mechanical toughener, a scratch resistance additive, a coupling agent, and any combination thereof.

In some embodiments, the artificial stone may further comprise a coupling agent. In some embodiments, the weight percentage of the coupling agent is between 0.001 to 1 wt. %. In some embodiments, the coupling agent is silane. In some embodiments, the weight percentage of the coupling agent is between 0.05 to 1.5 wt. %. In some embodiments, the weight percentage of the coupling agent is between 0.01 to 1 wt. %. In some embodiments, the weight percentage of the coupling agent is between 0.005 to 1 wt. %. In some embodiments, the weight percentage of the coupling agent is between 0.005 to 0.5 wt. %. In some embodiments, the amount of coupling agent is at least, 0.001 wt. %., 0.002 wt. %. 0.003 wt. %., 0.004 wt. %. 0.005 wt. %., 0.007 wt. %., 0.01 wt. %., 0.02 wt. %., 0.03 wt. %., 0.05 wt. %., 0.07 wt. %., 0.08 wt. %., 0.1 wt. %., 0.2 wt. %., 0.3 wt. %., 0.4 wt. %, and 0.05 wt. %. In some embodiments, the amount of coupling agent is at most 0.5 wt. %, 0.7 wt. %, 0.8 wt. %, 0.9 wt. %, 1 wt. %, 1.1 wt. %, 1.2 wt. %, 1.3 wt. %, 1.5 wt. %, 1.7 wt. %, and 2 wt. %.

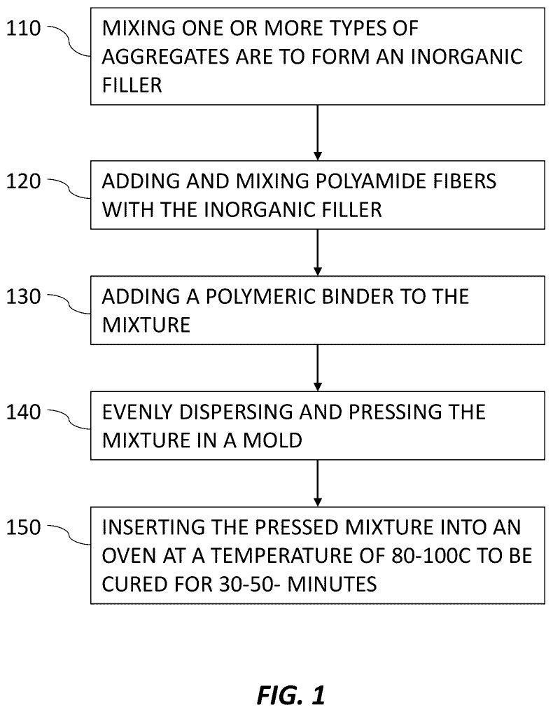

Reference is now made to FIG. 1 which is a flowchart of a method for manufacturing an artificial stone according to some embodiments of the invention. In step 110, one or more types of aggregates are mixed to form an inorganic filler. In step 120, the polyamide fibers are added and mixed with the inorganic filler. In step 130, a polymeric binder may be added to the mixture. In some embodiments, the final mixture may include at least 80 wt. % of the inorganic filler, at least 6 wt. % of the polymeric binder, and at least 0.01 wt. % polyamide fibers characterized by an average length of between 0.05 to 50 mm. In step 140, the mixture is evenly dispersed in a mold and pressed, for example, using a vibrating press. In step 150, the pressed mixture is inserted into an oven at a temperature of 80-100 C to be cured for 30-50-minutes, to form a slab.

In some embodiments, after curing, the slab is cooled down and then goes through a calibration and polishing process.

### Experimental Results

Several slabs were made according to some embodiments of the invention. The basic mixture included 12.15 wt. % unsaturated polyester, 0.25 wt. % peroxide, 84.1 wt. % quartz particles, and 3.5 wt. % pigment. Various amounts of polyamide fibers were added to the mixture. The crack resistance and impact resistance were measured using standard methods ASTM C-1421 and EN 14617-9

TABLE 1
summarizes the test results.

| | | | | | | Crack | Impact |
|---|---|---|---|---|---|---|---|
| | | | | | | resistance | resistance |
| | | L- | D- | | Quantity | improve- | improve- |
| | Fiber | Length | Diameter | L/D | [% wt of | ment | ment |
| # | type | [mm] | [μm] | ratio | mixture] | [%] * | [%] |
| 1 | Nylon | 3 | 27 | 111.11 | 0.04 | 3 | 13 |
| | 6-6 | | | | | | |
| 2 | Nylon | 3 | 27 | 111.11 | 0.1 | 10 | 33 |
| | 6-6 | | | | | | |
| 3 | Nylon | 3 | 27 | 111.11 | 0.34 | 20 | 46 |
| | 6-6 | | | | | | |
| 4 | Nylon | 3 | 27 | 111.11 | 0.52 | 139 | 46 |
| | 6-6 | | | | | | |
| 5 | Nylon | 3 | 27 | 111.11 | 0.78 | 123 | 46 |
| | 6-6 | | | | | | |
| 6 | Nylon | 6 | 27 | 222.22 | 0.04 | 2 | −5 |
| | 6-6 | | | | | | |
| 7 | Nylon | 6 | 27 | 222.22 | 0.1 | 11 | 16 |
| | 6-6 | | | | | | |
| 8 | Nylon | 6 | 27 | 222.22 | 0.34 | 50 | 37 |
| | 6-6 | | | | | | |
| 9 | Nylon | 6 | 27 | 222.22 | 0.52 | 104 | 50 |
| | 6-6 | | | | | | |
| 10 | Nylon | 12 | 27 | 444.44 | 0.04 | 24 | 14 |
| | 6-6 | | | | | | |
| 11 | Nylon | 12 | 27 | 444.44 | 0.1 | 30 | 14 |
| | 6-6 | | | | | | |
| 12 | Nylon | 12 | 27 | 444.44 | 0.34 | 59 | 14 |
| | 6-6 | | | | | | |
| 13 | Nylon | 18 | 27 | 666.67 | 0.04 | 28 | 0 |
| | 6-6 | | | | | | |
| 14 | Nylon | 18 | 27 | 666.67 | 0.1 | 27 | 11 |
| | 6-6 | | | | | | |
| 15 | Nylon | 18 | 27 | 666.67 | 0.34 | 83 | 14 |
| | 6-6 | | | | | | |
| | Nylon | 18 | 200 | 90 | 0.04 | 2 | 17 |
| | 6-6 | | | | | | |
| | Nylon | 18 | 200 | 90 | 0.1 | 11 | 25 |
| | 6-6 | | | | | | |
| | Nylon | 18 | 200 | 90 | 0.34 | 15 | 42 |
| | 6-6 | | | | | | |
| | Nylon | 12 | 13 | 923 | 0.04 | 6 | 3 |
| | 6-6 | | | | | | |
| | Nylon | 12 | 13 | 923 | 0.1 | 18 | 10 |
| | 6-6 | | | | | | |
| | Nylon | 12 | 13 | 923 | 0.34 | 33 | 10 |
| | 6-6 | | | | | | |

As clearly shown in the table the higher is the amount of fibers the better are the crack resistance and impact resistance. The length of the fibers has little effect on the impact resistance but has a dramatic effect on the crack resistance, as the higher the L/D ratio the higher is the crack resistance, for the same amount of fibers.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An artificial stone comprising:
at least 80 wt. % of an inorganic filler;
at least 6 wt. % of a polymeric binder; and
polyamide fibers characterized by an average length of between 0.05 to 50 mm, in a weight percentage of at least 0.01 wt. %.

2. The artificial stone of claim 1, wherein the polyamide fibers are further characterized by an average diameter of between 5 to 300 μm.

3. The artificial stone of claim 1, wherein the ratio between the length to the average diameter of the polyamide fibers is between 50 to 100.

4. The artificial stone of claim 1, wherein the weight percentage of the polyamide fibers is between 0.01 to 5 wt. %.

5. The artificial stone of claim 1, wherein the polymeric binder is a thermoset resin.

6. The artificial stone of claim 5, wherein the thermoset resin is selected from unsaturated polyester, acrylic, epoxy, polyurethane resin, or any combination thereof.

7. The artificial stone of claim 1, wherein the weight percentage of the polymeric binder is between 6 to 17 wt. %.

8. The artificial stone of claim 1, further comprising a coupling agent.

9. The artificial stone of claim 8, wherein the weight percentage of the coupling agent is between 0.001 to 1 wt. %.

10. The artificial stone of claim 9, wherein the coupling agent is silane.
